(19) United States
(12) Patent Application Publication
(10) Pub. No.: US 2025/0161965 A1
(43) Pub. Date: May 22, 2025

(54) Paint Trolley Device

(71) Applicant: Thomas Coleman, Clyde, OH (US)

(72) Inventor: Thomas Coleman, Clyde, OH (US)

(21) Appl. No.: 18/510,909

(22) Filed: Nov. 16, 2023

Related U.S. Application Data
(60) Provisional application No. 63/599,615, filed on Nov. 16, 2023.

(51) Int. Cl. B05B 9/00; B05B 9/01; B44D 3/12

(52) U.S. Cl. CPC B05B 9/007; B05B 9/01; B44D 3/12

(57) ABSTRACT

The present invention relates to a paint trolley device for storing and transporting large quantities of paint. The device is primarily comprised of a base with at least one wheel and a housing comprised of at least one compartment. The housing can hold a large quantity of paint, wherein the compartment has an air-tight lid that prevents paint from drying and spilling within the compartment. The device can be pulled via at least one handle or towed via a vehicle with at least one hitch.

### CROSS-REFERENCE TO RELATED APPLICATION

The present application claims priority to, and the benefit of, U.S. Provisional Application No. 63/599,615, which was filed on Nov. 16, 2023, and is incorporated herein by reference in its entirety.

### FIELD OF THE INVENTION

The present invention relates generally to the field of paint storage and transporting devices. More specifically, the present invention relates to a paint trolley device for storing and transporting large quantities of paint. The device is primarily comprised of a base with at least one wheel and a housing comprised of at least one compartment. The housing can hold a large quantity of paint. The compartment has an air-tight lid that prevents paint from drying and spilling within the compartment. The device can be pulled via at least one handle or towed via a vehicle with at least one hitch. The device may also be comprised of a quick connector to allow the paint to be transferred into the compartment through a filter contained beneath the air-tight lid. The compartment also contains a second filter before the outlet tube which supplies the paint spraying device. The compartment also has at least one valve in bottom of the compartment to facilitate cleaning and emptying of the compartment. Accordingly, the present disclosure makes specific reference thereto. Nonetheless, it is to be appreciated that aspects of the present invention are also equally applicable to other like applications, devices, and methods of manufacture.

### BACKGROUND

Painters applying paint to large-scale painting projects typically need to spend considerable time refilling their 5-gallon paint buckets. Spending time replacing paint in a paint bucket can be frustrating and reduce overall efficiency. Therefore, more than one person may be needed to operate a paint sprayer pump to ensure the painter can keep applying paint to a surface while having an adequate supply of paint. This is also undesirable as it requires an additional individual.

Therefore, there exists a long-felt need in the art for an improved painting device. There also exists a long-felt need in the art for a paint trolley device that allows users to store a large quantity of paint. In addition, there exists a long-felt need in the art for a paint trolley device that eliminates the need for a user to refill paint buckets. Further, there exists a long-felt need in the art for a paint trolley device that can be easily moved to different painting areas. Finally, there exists a long-felt need in the art for a paint trolley device that can be used in conjunction with paint-spraying devices.

The subject matter disclosed and claimed herein, in one embodiment thereof, comprises a paint trolley device. The device is primarily comprised of a base with at least one wheel and a housing comprised of at least one compartment. The housing can hold a large quantity of paint. The compartment has an air-tight lid that prevents paint from drying and spilling within the compartment. The device can be pulled via at least one handle or towed via a vehicle with at least one hitch. The device may also be comprised of a quick connector to allow the paint to be transferred into the compartment through a filter contained beneath the air-tight lid. The compartment also contains a second filter before the outlet tube which supplies the paint spraying device. The compartment also has at least one valve in bottom of the compartment to facilitate cleaning and emptying of the compartment. The device may also be comprised of a paint sprayer and a fastener to secure the paint sprayer to the base.

In this manner, the paint trolley device of the present invention accomplishes all the foregoing objectives and provides a paint trolley device that allows users to store a large quantity of paint, thereby eliminating the need for a user to refill paint buckets. Further, the device can be easily moved to different painting areas and can be used in conjunction with paint-spraying devices.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a paint trolley device. The device is primarily comprised of a base with at least one wheel and a housing comprised of at least one compartment. The base has at least one wheel that allows the device to be easily moved. In the preferred embodiment, the device is comprised of at least one axle with at least two wheels. One embodiment of the device is comprised of at least one hitch that allows the device to be attached to a vehicle/machinery and towed.

The base is also comprised of at least one housing comprised of at least one, but preferably two compartments. The compartments store paint, thereby allowing large quantities of paint to be easily transported and accessed using the device. The compartments preferably hold between (but are not limited to) 15-100 gallons of paint each (or combined).

The compartment is comprised of a lid that is preferably air-tight such that paint within the compartment does not dry while being stored within the device. The lid may also be comprised of at least one lock that allows the lid to be secured in a closed position during transport to avoid spilling paint.

The housing may be comprised of at least one quick connector that is in fluid communication with the compartment via at least one tubing/piping. The connector may be any female/male style quick connector or connection mechanism known in the art that can be attached to a paint source to allow the paint to be transferred into the compartment. At least one filter is preferably positioned within the tubing between the connector and housing to prevent solids within the paint from entering the housing. The compartment also contains a second filter before the outlet tube which supplies the paint spraying device. The compartment also has at least one valve in bottom of the compartment to facilitate cleaning and emptying of the compartment.

The tubing and connector may also connect the compartment to at least one paint sprayer. The sprayer is preferably an airless paint sprayer. The sprayer can be used to spray paint from the compartment. The sprayer may be comprised of at least one fastener that removably secures the sprayer to the base. This prevents the sprayer from falling from the device.

Accordingly, the paint trolley device of the present invention is particularly advantageous as it provides a paint trolley device that allows users to store a large quantity of paint. This eliminates the need for a user to refill paint buckets. Further, the device can be easily moved to different painting areas and can be used in conjunction with paint-spraying devices. In this manner, the paint trolley device overcomes the limitations of existing methods of painting known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a paint trolley device of the present invention in accordance with the disclosed architecture;

FIG. 2 illustrates a perspective view of one potential embodiment of a paint trolley device of the present invention while attached to a vehicle in accordance with the disclosed architecture;

FIG. 3 illustrates a partially exploded view of one potential embodiment of a paint trolley device of the present invention while filled with paint in accordance with the disclosed architecture; and

FIG. 4 illustrates a partially exploded view of one potential embodiment of a paint trolley device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved painting device. There also exists a long-felt need in the art for a paint trolley device that allows users to store a large quantity of paint. In addition, there exists a long-felt need in the art for a paint trolley device that eliminates the need for a user to refill paint buckets. Further, there exists a long-felt need in the art for a paint trolley device that can be easily moved to different painting areas. Finally, there exists a long-felt need in the art for a paint trolley device that can be used in conjunction with paint spraying devices.

The present invention, in one exemplary embodiment, is comprised of a paint trolley device primarily comprised of a base with at least one wheel and a housing comprised of at least one compartment. The base has at least one wheel that allows the device to be easily moved. In the preferred embodiment, the device is comprised of at least one axle with at least two wheels. One embodiment of the device is comprised of at least one hitch. The hitch allows the device to be attached to a vehicle/machinery and towed.

The base is also comprised of at least one housing. The housing is comprised of at least one, but preferably two, compartments that store paint. In this manner, large quantities of paint can be easily transported and accessed using the device. The compartments preferably hold between (but are not limited to) 15-100 gallons of paint each (or combined).

The compartment is comprised of a lid. The lid is preferably air-tight such that paint within the compartment does not dry while being stored within the device. The lid may also be comprised of at least one lock. The lock allows the lid to be secured in a closed position during transport to avoid spilling paint.

The housing may be comprised of at least one quick connector that is in fluid communication with the compartment via at least one tubing/piping. The connector may be any female/male style quick connector or connection mechanism known in the art. The connector can be attached to a paint source to allow the paint to be transferred into the compartment. At least one filter is preferably positioned within the tubing between the connector and housing to prevent solids within the paint from entering the housing. The compartment also contains a second filter before the outlet tube which supplies the paint spraying device. The compartment also has at least one valve in bottom of the compartment to facilitate cleaning and emptying of the compartment.

The tubing and connector may also connect the compartment to at least one paint sprayer that is preferably an airless paint sprayer. The sprayer can be used to spray paint from the compartment. The sprayer may be comprised of at least one fastener that removably secures the sprayer to the base. This prevents the sprayer from falling from the device.

Accordingly, the paint trolley device of the present invention is particularly advantageous as it provides a paint trolley device that allows users to store a large quantity of paint. This eliminates the need for a user to refill paint buckets. Further, the device can be easily moved to different painting areas and can be used in conjunction with paint-spraying devices. In this manner, the paint trolley device overcomes the limitations of existing methods of painting known in the art.

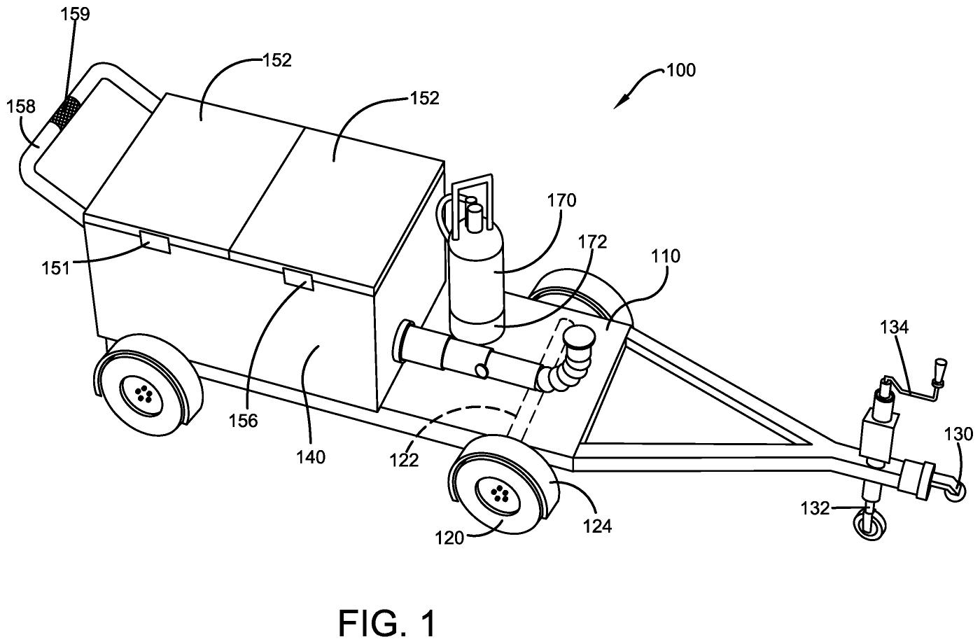

Referring initially to the drawings, FIG. 1 illustrates a perspective view of one potential embodiment of a paint trolley device 100 of the present invention in accordance with the disclosed architecture. The device 100 is primarily comprised of a base 110 with at least one wheel 120 and a housing 140 comprised of at least one compartment 150. The device 100 and all components may be made from a plurality of materials in different embodiments in different combinations. Said materials include, but are not limited to, metal such as stainless steel or aluminum. The device 100 may also be comprised of a rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

The base 110 may be any shape but is preferably rectangular. The base 110 has at least one wheel 120 which allows the device 100 to be easily moved. In the preferred embodiment, the device 100 is comprised of at least one axle 122 with at least two wheels 120. The wheels 120 may be any type known in the art such as, but not limited to, inflatable wheels, run-flat wheels, non-puncturable wheels, solid wheels, all-terrain wheels, etc. In one embodiment, each wheel 120 may be protected by at least one fender 124.

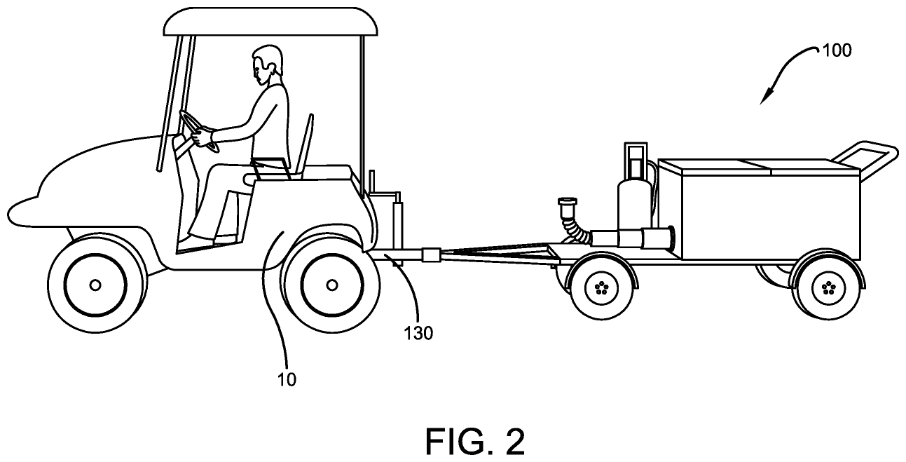

FIG. 2 illustrates a perspective view of one potential embodiment of a paint trolley device 100 of the present invention while attached to a vehicle 10 in accordance with the disclosed architecture. One embodiment of the device 100 is comprised of at least one hitch 130. The hitch 130 may be any hitch type known in the art which allows the device 100 to be attached to a vehicle/machinery 10 and towed. The hitch 130 may be, but is not limited to, a tow ball hitch. In this manner, the device 100 can be easily moved over long distances.

The base 110 may also be comprised of at least one trailer leg 132. The leg 132 supports the base 110 when the device 100 is not connected to vehicle/machinery 10. The leg 132 can be raised/lowered by at least one crank handle 134. The leg 132 may be any type of trailer leg known in the art.

The base 110 is also comprised of at least one housing 140. The housing 140 is comprised of at least one, but preferably two compartments 150. The compartments store paint 20, thereby allowing large quantities of paint 20 to be easily transported and accessed when using the device 100. In any embodiment with multiple compartments 150, the compartments 150 are separated by at least one divider wall 142. The compartments 150 preferably hold between (but are not limited to) 15-100 gallons of paint 20 each (or combined).

The compartment 150 is comprised of a lid 152. The lid 152 is preferably air-tight such that paint within the compartment 150 does not dry while being stored within the device 100. The lid 152 may be comprised of at least one air-tight seal 154 of any type known in the art to prevent paint 20 from drying within the compartment 150.

The lid 152 may also be comprised of at least one lock 156. The lock 156 allows the lid 152 to be secured in a closed position during transport to avoid spilling paint 20. The lock 156 may be any locking mechanism known in the art such as, but not limited to, a lock, a clasp, a latch, etc.

The lid 152 may also be comprised of at least one hinge 151. The hinge 151 allows the lid 152 to be flipped open. The hinge 151 may be any hinge type known in the art such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc.

The housing 140 and/or lid 152 may be comprised of at least one handle 158. The handle 140 may allow the lid 152 to be easily opened and/or the device 100 to be easily pulled manually. The handle 158 may be comprised of at least one grip area 159. The grip area 159 may be textured with a recessed or raised texture or may be non-textured. The grip area is preferably made from a non-slip material that improves grip such as, but not limited to, silicone, latex, neoprene, EPDM, PVC foam, polyethylene, sponge rubber, silicone foam, urethane, cork, ridged and/or recessed rubber, felt, acrylic, polyester & SBR, etc.

The housing 140 may be comprised of at least one quick connector 162 that is in fluid communication with the compartment 150 via at least one tubing/piping 166. The connector 162 may be any female/male style quick connector or connection mechanism known in the art. In this manner, the connector 162 can be attached to a paint source to allow paint 20 to be transferred into the compartment 150. At least one hose 180 and sprayer 190 (of any type known in the art) may be attached to the connector 162.

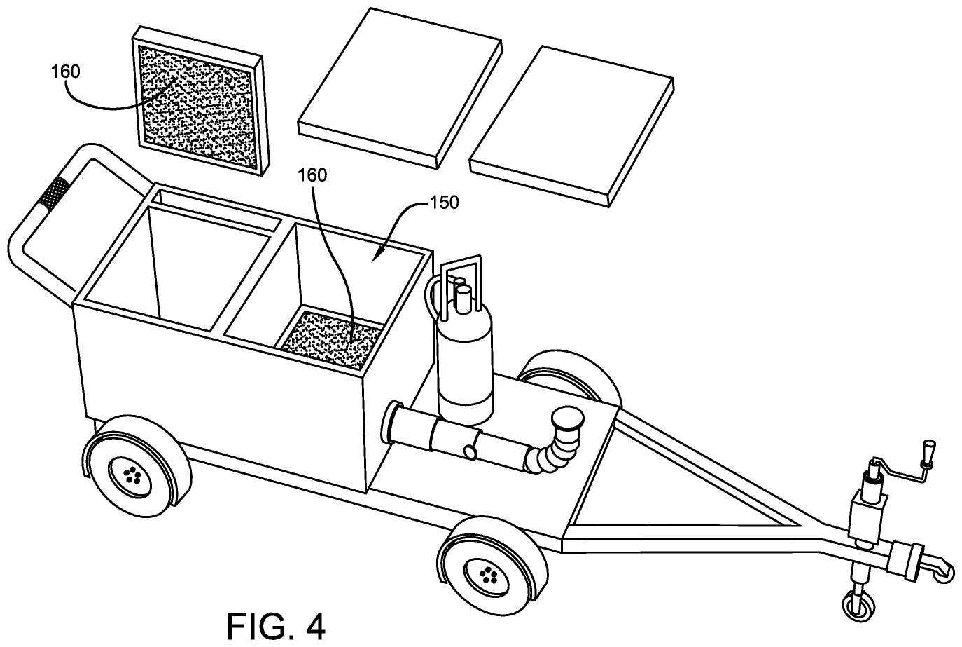

At least one filter 160 may be positioned within the tubing 166 between the connector 162 and housing 140. The filter 160 may also be placed within the compartment 150 such that is removable/replaceable, as seen in FIG. 4. The filter 160 may be replaceable and can be any screen filter or filter type known in the art that prevents solids within paint 20 from entering the housing 140. Flow of paint into the compartment 150 can be stopped by at least one shutoff valve 164 on the tubing 166.

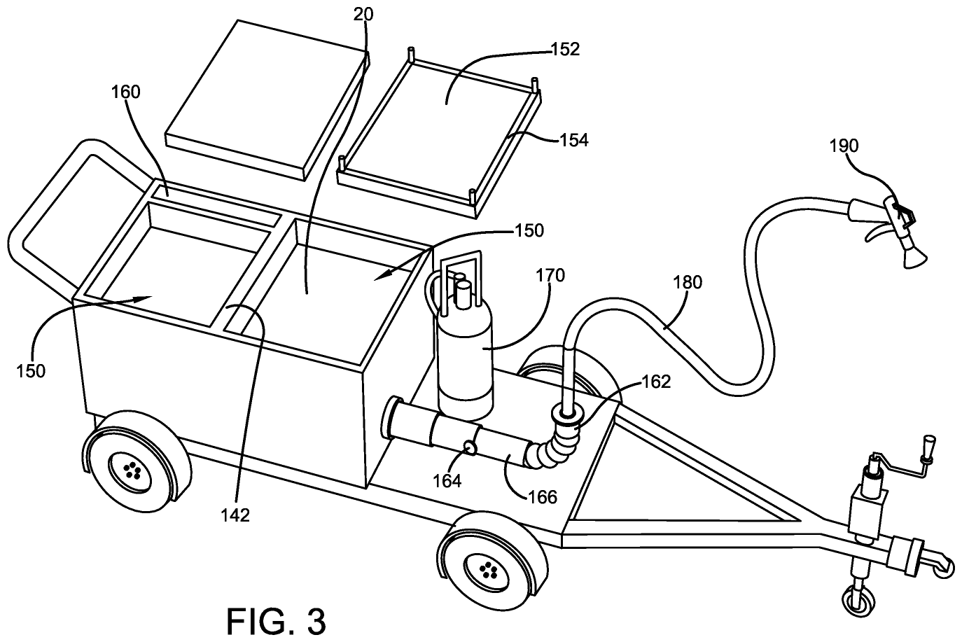

The tubing 166 and connector 162 may also connect the compartment 150 to at least one paint sprayer 170. The sprayer 170 may be any paint sprayer known in the art. However, the sprayer 170 is preferably an airless paint sprayer. The sprayer 170 propels paint 20 from the compartment 150, through the hose 180, and out the sprayer 190 as seen in FIG. 3.

The sprayer 170 and/or base 110 may be comprised of at least one fastener 172. The fastener 172 removably secures the sprayer 170 to the base 110, especially during transport. This prevents the sprayer 170 from falling from the device 100. In the preferred embodiment, the fastener 172 is a magnet. However, the fastener 172 may be any fastener type known in the art such as, but not limited to, a clip, a tie, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “paint trolley device” and “device” are interchangeable and refer to the paint trolley device 100 of the present invention.

Notwithstanding the foregoing, the paint trolley device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the paint trolley device 100 as shown in the FIGS. are for illustrative purposes only, and that many other sizes and shapes of the paint trolley device 100 are well within the scope of the present disclosure. Although the dimensions of the paint trolley device 100 are important design parameters for user convenience, the paint trolley device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paint trolley device comprising:
a base;
a wheel;
a housing;
a compartment;
a lid;
a tubing;
a quick-connector; and
a filter.

2. The paint trolley device of claim 1, wherein the filter is positioned within the compartment.

3. The paint trolley device of claim 1, wherein the wheel is comprised of a select one of an inflatable wheel, a run-flat wheel, a non-puncturable wheel, a solid wheel or an all-terrain wheel.

4. A paint trolley device comprising:
a base;
a hitch;
a wheel;
a housing;
a compartment;
a lid;
a seal;
a tubing;
a quick-connector; and
a filter.

5. The paint trolley device of claim 1, wherein the lid attaches to the housing via a hinge.

6. The paint trolley device of claim 1, wherein the lid is comprised of a lock.

7. The paint trolley device of claim 1, wherein the handle is comprised of a grip area.

8. The paint trolley device of claim 1, wherein the filter is positioned within the tubing.

9. A paint trolley device comprising:
a base;
a hitch;
a wheel;
a housing;
a compartment;
a lid;
a leg;
a seal;
a tubing;
a quick-connector; and
a filter.

10. The paint trolley device of claim 9 further comprised of a crank handle.

11. The paint trolley device of claim 9, wherein the seal is positioned on the lid.

12. The paint trolley device of claim 11, wherein the seal is comprised of an air-tight seal.

13. The paint trolley device of claim 9, wherein the compartment is in fluid communication with the tubing.

14. The paint trolley device of claim 9, wherein the quick-connector attaches to a hose and a sprayer.

15. The paint trolley device of claim 9 further comprised of a paint sprayer.

16. The paint trolley device of claim 15, wherein the paint sprayer is an airless paint sprayer.

17. The paint trolley device of claim 15, wherein the paint sprayer is secured to the base via a fastener.

18. The paint trolley device of claim 15, wherein the paint sprayer is in fluid communication with the compartment.

19. The paint trolley device of claim 9 further comprised of a shutoff valve.

20. The paint trolley device of claim 9, wherein the quick-connector is comprised of a female quick-connector.
